(19) United States
(12) Patent Application Publication
(10) Pub. No.: US 2010/0134446 A1
(43) Pub. Date: Jun. 3, 2010

(54) OPTICAL OUTPUT DEVICE

(75) Inventors: Ruey-Jiann LIN, Jhupei (TW); Shen-Hui CHEN, Hsin-Chu City (TW); Ching-Han CHEN, Kinmen County (TW)

Correspondence Address: Muncy, Geissler, Olds & Lowe, PLLC, 4000 Legato Road, Suite 310, FAIRFAX, VA, 22033, US

(73) Assignee: TRON INTELLIGENCE INC., Jhupei (TW)

(21) Appl. No.: 12/625,294

(22) Filed: Nov. 24, 2009

(30) Foreign Application Priority Data
Nov. 28, 2008 (TW) 097221408

(51) Int. Cl. G06F 3/042

(52) U.S. Cl. 345/175

(57) ABSTRACT

The present invention discloses an optical input device, which comprises a display panel having a displaying area functioning as an interface for detecting a position of an object; a backlight module providing light sources for the display panel; and at least one image sensor arranged behind the backlight module and capturing a positional image, which is formed on the displaying area by an object reflecting the light emitted by the light sources. The present invention not only can decrease the thickness of the optical input device but also can reduce the complexity of the optical system.

### BACKGROUND OF THE INVENTION

1. Field of the Invention

The present invention relates to an input device, particularly to an optical input device.

2. Description of the Related Art

Generally, signals are input into an electronic device, such as a computer or a mobile phone, via an external keyboard. However, such a design is hard to achieve a slim and compact electronic product.

To reduce the volume of devices, the keyboard function is incorporated into the display panel to form the so-called touchscreen. The touchscreens may be categorized into the resistive type, the capacitive type, the ultrasonic type and the optical type. The optical type touchscreen operates via receiving reflected light. Refer to FIG. 1 and FIG. 2 for a conventional optical type touchscreen. Infrared sources 12 and infrared cameras 14 are arranged below a projection screen 10 to form arrays. An object 16 contacting the projection screen 10 reflects light to the infrared cameras 14. The infrared cameras 14 send signals to a control computer; the computer locates the position of the object 16 and then controls a projector 18 to project a related image on the projection screen 10. In such a design, each infrared camera 14 can only cover a limited area. Besides, the infrared sources 12 have to uniformly illuminate the projection screen 10. Thus, the projection screen 10 has to be elevated to increase the coverage of the infrared cameras 14 and make the infrared sources 12 illuminate the projection screen 10 uniformly. However, such a measure greatly increases the thickness of the display device (a thickness as great as a shown in FIG. 2). Further, the optical system, wherein a projector cooperates with infrared sources, has a higher complexity. Therefore, the conventional optical type touchscreen has a high price.

Accordingly, the present invention proposes an optical input device, which applies to general flat panel displays and has a smaller thickness and a lower system complexity, to solve the abovementioned problems.

### SUMMARY OF THE INVENTION

The primary objective of the present invention is to provide an optical input device, wherein the image sensors are incorporated in a display panel and arranged behind the backlight module to reduce the thickness of the device and decrease the complexity of the system.

To achieve the abovementioned objectives, the present invention proposes an optical input device, which comprises a display panel having a displaying area functioning as an interface to detect the position of an object; a backlight module providing light for the display panel; and at least one image sensor arranged behind the backlight module and obtaining a positional image formed on the displaying area by the light reflected from the object.

Below, the embodiments are described in detail in cooperation with the attached drawings to make easily understood the characteristics, technical contents and accomplishments of the present invention.

### BRIEF DESCRIPTION OF THE DRAWINGS

FIG. 1 is a perspective view schematically showing a conventional optical type touchscreen;

FIG. 2 is a front view schematically showing a conventional optical type touchscreen;

FIG. 3 is a perspective view schematically showing an optical input device according to a first embodiment of the present invention;

FIG. 4 is a front view schematically showing an optical input device according to the first embodiment of the present invention;

FIG. 5 is a perspective view schematically showing an optical input device according to a second embodiment of the present invention;

FIG. 6 is a front view schematically showing an optical input device according to the second embodiment of the present invention;

FIG. 7 is a perspective view schematically showing an optical input device according to a third embodiment of the present invention;

FIG. 8 is a front view schematically showing an optical input device according to the third embodiment of the present invention;

FIG. 9 is a perspective view schematically showing an optical input device according to a fourth embodiment of the present invention; and

FIG. 10 is a front view schematically showing an optical input device according to the fourth embodiment of the present invention.

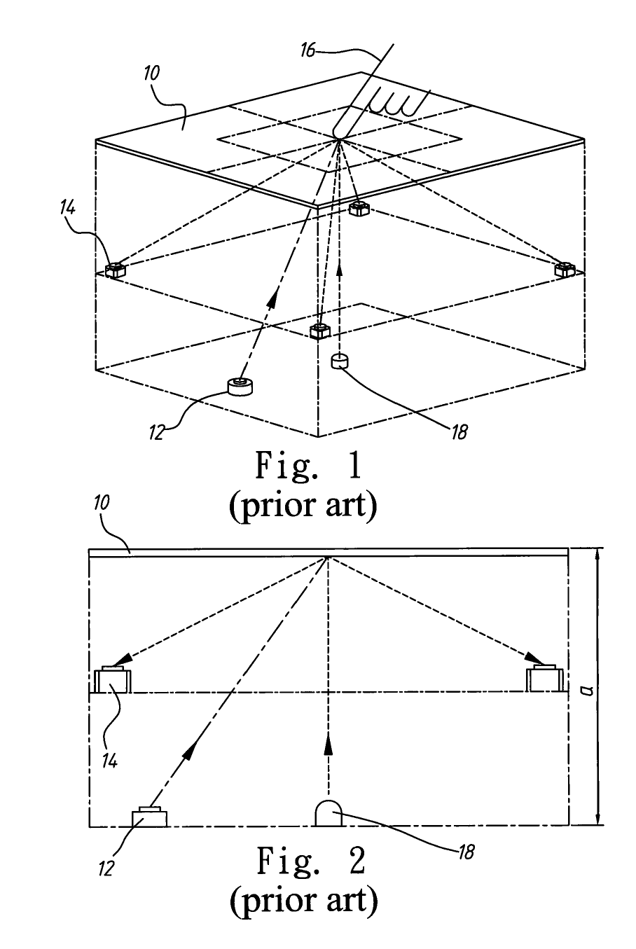

### DETAILED DESCRIPTION OF THE INVENTION

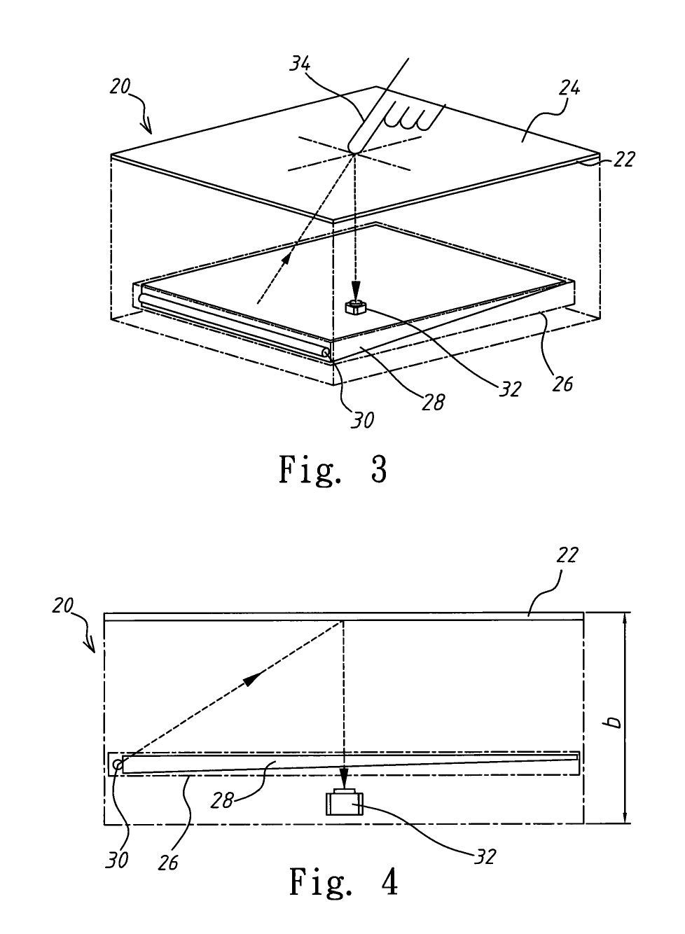

As the projector and the infrared sources cause the thickness of the device to increase in the conventional technology, the present invention replaces the projector with a flat panel display and replaces the infrared sources with a backlight module. Refer to FIG. 3 and FIG. 4 for a first embodiment of the present invention. The optical input device 20 of the present invention comprises a display panel 22, a backlight module 26 and at least one image sensor 32. The display panel 22 has a display area 24 functioning as an interface to detect the position of an object 34, such as a finger. The backlight module 26 provides light sources for the display panel 22. The image sensor 32 obtains a positional image formed on the displaying area 24 by the light reflected from the object 34. The optical input device 20 of the present invention further comprises a processor 32 coupled to the image sensor 32, receiving a signal from the image sensor, processing the image captured by the image sensor 32 to obtain a complete detection image. The processor may be a single-core or multi-core processor integrated with a computer.

In the present invention, the backlight module 26 is arranged between the image sensor 32 and the display panel 22. The backlight module 26 cannot have any metallic reflecting layer lest the sensitivity that the image sensor 32 detects the positional image of the object 34 be affected. In the first embodiment, the backlight module 26 includes a light guide plate 28 and a light-emitting device 30. The light-emitting device 30 is arranged on a lateral of the light guide plate 28 and provides lights, including visible light and infrared light. The visible light is used to present images on the display panel 22. The infrared light is used to detect the position of the object 34. The light guide plate 28 is used to distribute light uniformly.

Below is described the operation of the optical input device 20 of the present invention. When approaching or contacting the displaying area 24 of the display panel 22, the object 34 shields the light emitted by the backlight module 26 and forms a positional image on the displaying area 24. At the same time, infrared light is reflected by the object 34 to pass through the light guide plate 28 of the backlight module 26 and then reach the image sensors 32, whereby the image sensor 32 obtains the positional image. Next, the image sensor 32 outputs a signal to the processor. The processor receives the signal and processes the positional image obtained by the image sensor 32 into a complete detection image. Thereby, the processor can accurately determine the position where the object 34 contacts the displaying area 24.

The optical input device 20 of the first embodiment has a thickness b, which is smaller than the thickness a of the conventional optical type touchscreen shown in FIG. 2.

A single image sensor 32 can only have a limited view field except the distance between the display panel 22 and the image sensor 32 is increased. To increase the view field without increasing the thickness, a second embodiment of the present invention replaces the single image sensor 32 with a plurality of image sensors 32 arranged into an array. At the same time, the displaying area 24 is divided into a plurality of blocks each corresponding to one image sensor 32.

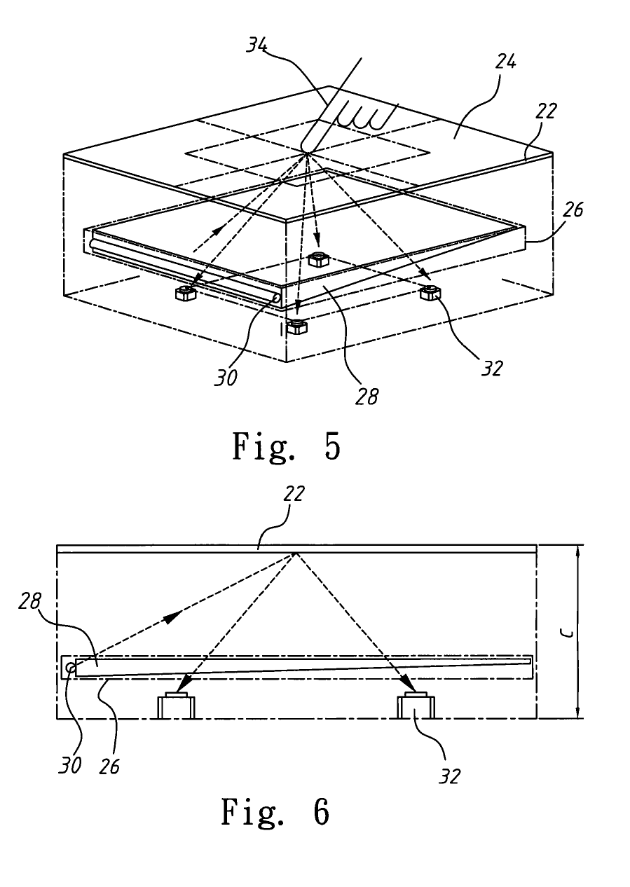

Refer to FIG. 5 and FIG. 6 for the second embodiment of the present invention. The second embodiment is different from the first embodiment in that the second embodiment has four image sensors 32 and that the displaying area 24 is divided into four blocks. The image sensors 32 are arranged into a square array. Each image sensor 32 is corresponding to a block most near to it. When an object 34 shields light and generates a positional image, the image sensors 32 respectively receive reflected infrared light through the corresponding blocks. The processor may be a single-core or multi-core processor. If the processor is a single-core processor, the processor simultaneously processes the signals sent out by all the image sensors 32 and integrates the images obtained by the image sensors 32 into a complete detection image. If the processor is a multi-core processor, the cores thereof respectively receive the images obtained by the image sensors 32, process the signals and then integrate the images, whereby the processor can faster obtain a complete detection image.

The optical input device 20 of the second embodiment has a thickness c, which is smaller than the thickness b of the optical input device 20 of the first embodiment shown in FIG. 4.

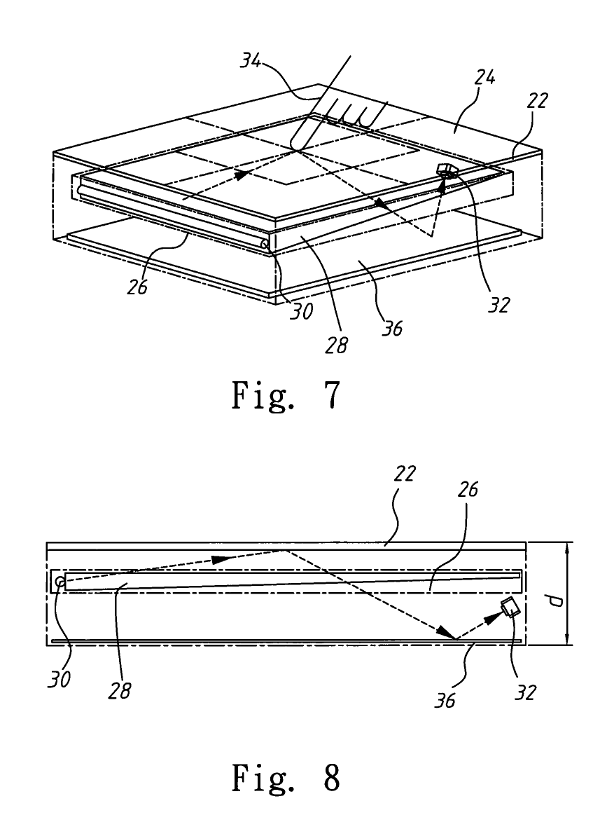

Refer to FIG. 7 and FIG. 8 for a third embodiment of the present invention. The third embodiment is different from the first embodiment in that the third embodiment has a reflecting plate 36 facing the displaying area 24 and corresponding to the image sensor 32. The reflecting plate 36 has an area sufficient to reflect the light from the displaying area 24. When an object 34 shields light and generates a positional image, the reflecting plate 36 reflects the infrared light, which has been reflected by the object 34 beforehand, to the image sensor 32, whereby the transmission path of the light is shortened. Thus, the image sensor 32 receives the positional image. Via the reflecting plate 36, the optical input device 20 of the third embodiment has a smaller thickness than the optical input device 20 of the first embodiment. In other words, the optical input device 20 of the third embodiment has a thickness d, which is smaller than the thickness b of the optical input device 20 of the first embodiment shown in FIG. 4.

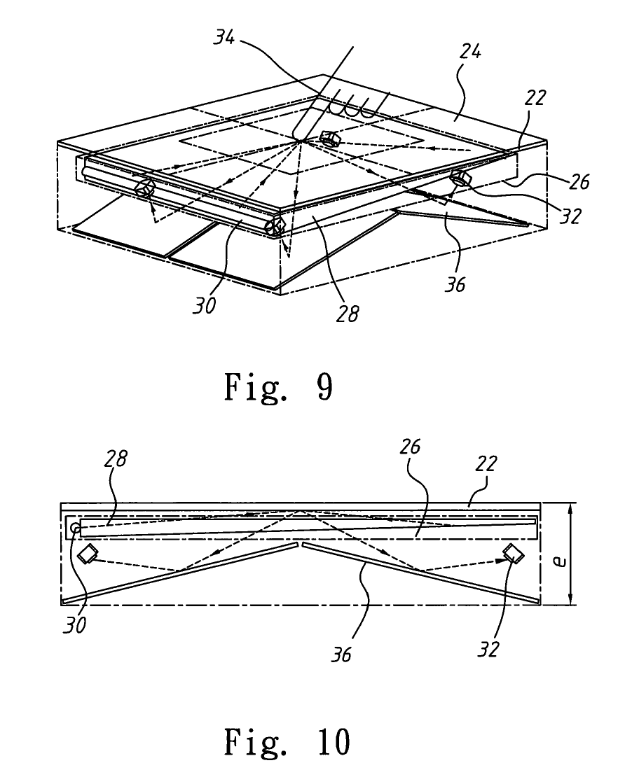

Refer to FIG. 9 and FIG. 10 for a fourth embodiment of the present invention. The fourth embodiment is different from the second embodiment in that each image sensor 32 has a reflecting plate 36 facing a block (of the displaying area 24) corresponding to the image sensor 32. The reflecting plate 36 has an area sufficient to reflect the light from the corresponding block on the displaying area 24. When an object 34 shields light and generates a positional image, each reflecting plate 36 reflects the infrared light, which has been reflected by the object 34 to pass through the corresponding block, to the corresponding image sensor 32, whereby the transmission path of the light is shortened. Thus, the image sensor 32 receives the positional image. Via the reflecting plates 36, the optical input device 20 of the fourth embodiment has a smaller thickness than the optical input device 20 of the second embodiment. In other words, the optical input device 20 of the fourth embodiment has a thickness e, which is smaller than the thickness c of the optical input device 20 of the second embodiment shown in FIG. 6.

In conclusion, the present proposes an optical input device, whose backlight module replaces the infrared device used in the conventional technology. Therefore, the present invention needn't use an additional optical device to provide infrared light. Thus is reduced the thickness, complexity, design difficulty, and cost of the display device containing the optical input device.

The embodiments described above are only to exemplify the present invention but not to limit the scope of the present invention. Any equivalent modification or variation according to the shapes, structures, characteristics, or principles of the present invention is to be also included within the scope of the present invention.

What is claimed is:

1. An optical input device comprising
a display panel having a displaying area functioning as an interface for detecting a position of an object;
a backlight module providing light sources for said display panel; and
at least one image sensor arranged behind said backlight module and obtaining a positional image, which is formed on said displaying area by an object reflecting light emitted by said light sources.

2. The optical input device according to claim 1 further comprising a processor coupled to said image sensor, receiving a signal from said image sensor, and processing said positional image into a complete detection image.

3. The optical input device according to claim 1, wherein said at least one image sensor is a plurality of image sensors arranged into a square array; said displaying area is divided into a plurality of blocks each corresponding to one said image sensor.

4. The optical input device according to claim 2, wherein said processor is a single-core processor or a multi-core processor.

5. The optical input device according to claim 4, wherein when said at least one image sensor is a plurality of image sensors, cores of said multi-core processor respectively receive said positional images captured by said image sensors and integrate said positional images into a complete detection image.

6. The optical input device according to claim 2, wherein said processor is integrated with a computer.

7. The optical input device according to claim 1 further comprising at least one reflecting plate, which faces said displaying area and reflects said positional image to said image sensor, whereby said image sensor obtains said positional image.

8. The optical input device according to claim 1, wherein said backlight module further comprises
a light guide plate; and
a light emitting device arranged on a lateral of said light guide plate, wherein light emitted by said light emitting device is guided by said light guide plate to diffuse uniformly.
